(19) United States
(12) Patent Application Publication
(10) Pub. No.: US 2017/0185336 A1
(43) Pub. Date: Jun. 29, 2017

(54) MEMORY SYSTEM AND OPERATING METHOD THEREOF

(71) Applicant: SK hynix Inc., Gyeonggi-do (KR)

(72) Inventor: Eu-Joon BYUN, Gyeonggi-do (KR)

(21) Appl. No.: 15/158,323

(22) Filed: May 18, 2016

(30) Foreign Application Priority Data
Dec. 24, 2015 (KR) 10-2015-0186089

(51) Int. Cl. G06F 3/06

(52) U.S. Cl. CPC G06F 3/0625; G06F 3/0685; G06F 3/0634

(57) ABSTRACT

A memory system may include: a memory device comprising a plurality of pages and a plurality of word lines; and a controller suitable for: performing a program operation to at least one selected page coupled to a single word line; performing an erase operation to the at least one selected page when the memory system is powered on after a power off interrupted the performing of the program operation to the at least one selected page; and re-performing the interrupted program operation to the erased at least one selected page.

### CROSS-REFERENCE TO RELATED APPLICATIONS

The present application claims priority of Korean Patent Application No. 10-2015-0186089, filed on Dec. 24, 2015, which is incorporated herein by reference in its entirety.

### BACKGROUND

1. Field

Exemplary embodiments relate to a semiconductor design technology, and, more particularly, to a memory system which processes data to a memory device and an operating method thereof.

2. Description of the Related Art

The computer environment paradigm has shifted to ubiquitous computing systems that can be used anytime and anywhere. Due to this, use of portable electronic devices such as mobile phones, digital cameras, and notebook computers has rapidly increased. These portable electronic devices generally use a memory system having memory devices for storing data, i.e., a data storage device. The data storage device is used as a main memory device or an auxiliary memory device of the portable electronic devices.

Data storage devices using memory devices provide excellent stability, durability, high information access speed, and low power consumption since they have no moving parts. Examples of data storage devices having such advantages include universal serial bus (USB) memory devices, memory cards having various interfaces, and solid state drives (SSD).

### SUMMARY

Various embodiments are directed to a memory system capable of minimizing the complexity and performance reduction of the memory system and maximizing the use efficiency of a memory device, thereby stably processing data, and an operating method thereof.

In an embodiment, a memory system may include: a memory device comprising a plurality of pages and a plurality of word lines; and a controller suitable for: performing a program operation to at least one selected page coupled to a single word line; performing an erase operation to the at least one selected page when the memory system is powered cm after a power off interrupted the performing of the program operation to the at least one selected page; and re-performing the interrupted program operation to the erased at least one selected page.

The controller may store segments of user data and meta-data corresponding to the program operation into a memory of the controller during the program operation, and the controller may program first segments of the segments to first pages of the selected pages at a first time point.

The controller may program second segments of the segments to second pages of the selected pages at a second time point of the power-off, the controller may perform the erase operation to the second pages at a third time point of the power-on after the second time point, and the controller may re-program the second segments, which are interrupted due to the power-off, to the erased second pages at a fourth time point after the third time point.

The controller may convert the second pages into empty pages or free pages through the erase operation at the third time point.

The first pages and the second pages may be coupled to the corresponding word lines, respectively, and the program operation may be an operation of one shot program.

The memory device may have a triple level, cell (TLC) structure.

The controller may determine whether the program operation to the selected pages is interrupted due to the power-off before performing the erase operation.

The controller may determine whether the selected pages are interrupted due to the power-off before performing the erase operation.

The power-off may be a sudden power-off.

In an embodiment, an operating method of a memory system comprising a controller and a plurality of pages coupled to a plurality of word lines, the operating method may include: performing a program operation to selected pages among the plural pages; performing an erase operation to the selected pages when power of the system is on after the power is off during the performing of the program operation to the selected pages; and resuming the program operation to the erased pages.

The performing of the program operation may include: storing segments of user data and meta-data corresponding to the program operation into a memory in the controller during the command operation; and programming first segments of the segments to first pages of the selected pages at a first time point.

The performing of the program operation may further include programming second segments of the segments to second pages of the selected pages at a second time point, the erase operation may be performed to the second pages at a third time point of the power-on after the second time point, and the program operation may be resumed by re-programming the second segments, which are interrupted due to the power-off, to the erased second pages at a fourth time point after the third time point.

The erase operation may be performed by converting the second pages into empty pages or free pages through the erase operation at the third time point.

The first pages and the second pages may be coupled to the corresponding word lines, respectively, and the program operation may be an operation of one shot program.

The plurality of pages f ay have a triple level cell (TLC) structure.

The operating method may further include determining whether the program operation to the selected pages is interrupted due to the power-off before performing the erase operation.

The operating method may further include determining whether the selected pages are interrupted due to the power-off before the performing of the erase operation.

The power-off may be a sudden power-off.

### BRIEF DESCRIPTION OF THE DRAWINGS

FIG. 1 is a diagram illustrating a data processing system including a memory system, according to an embodiment of the present invention.

FIG. 2 is a diagram illustrating a memory device employed in the memory system of FIG. 1, according to an embodiment of the present invention.

FIG. 3 is a circuit diagram illustrating a memory block in the memory device of FIG. 2, according to an embodiment of the present invention.

FIGS. 4 to 11 are diagrams schematically illustrating the memory device shown in FIG. 2, according to an embodiment of the present invention.

FIGS. 12 and 13 are diagrams schematically describing an example of a command operation to a memory device in a memory system, according to an embodiment of the present invention,

FIG. 14 is a flowchart schematically illustrating a command operation of the memory system, according to an embodiment of the present invention.

### DETAILED DESCRIPTION

Various embodiments will be described below in more detail with reference to the accompanying drawings. The present invention may, however, be embodied in different forms and should not be construed as being limited to the embodiments set forth herein. Rather, these embodiments are provided so that this disclosure will be thorough and complete, and will fully convey the present invention to those skilled in the art. Throughout the disclosure, like reference numerals refer to like parts throughout the various figures and embodiments of the present invention.

It will be understood that, although the terms “first”, “second”, “third”, and so on may be used herein to describe various elements, these elements are not limited by these terms. These terms are used to distinguish one element from another element. Thus, a first element described below could also be termed as a second or third element without departing from the spirit and scope of the present invention.

It be further understood that when an element is referred to as being “connected to”, or “coupled to” another element, it may be directly on, connected to, or coupled to the other element, or one or more intervening elements may be present. In addition, it will also be understood that when an element is referred to as being “between” two elements, it may be the only element between the two elements, or one or more intervening elements may also be present.

The terminology used herein is for the purpose of describing particular embodiments only and is not intended to be limiting of the present invention. As used herein, singular forms are intended to include the plural forms as well, unless the context clearly indicates otherwise. It will be further understood that the terms “comprises”, “comprising”, “includes”, and “including” when used in this specification, specify the presence of the stated elements and do not preclude the presence or addition of one or more other elements. As used herein, the term “and/or” includes any and all combinations of one or more of the associated listed items.

Unless otherwise defined, all terms including technical and scientific terms used herein have the same meaning as commonly understood by one of ordinary skill in the art to which the present invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

In the following description, numerous specific details are set forth in order to provide a thorough understanding of the present invention. The present invention may be practiced without some or all of these specific details. In other instances, well-known process structures and/or processes have not been described in detail in order not to unnecessarily obscure the present invention.

It is also noted, that in some instances, as would be apparent to those skilled in the relevant art, an element described in connection with one embodiment may be used singly or in combination with other elements of another embodiment, unless otherwise specifically indicated.

Hereinafter, the various embodiments of the present invention will be described in detail with reference to the attached drawings.

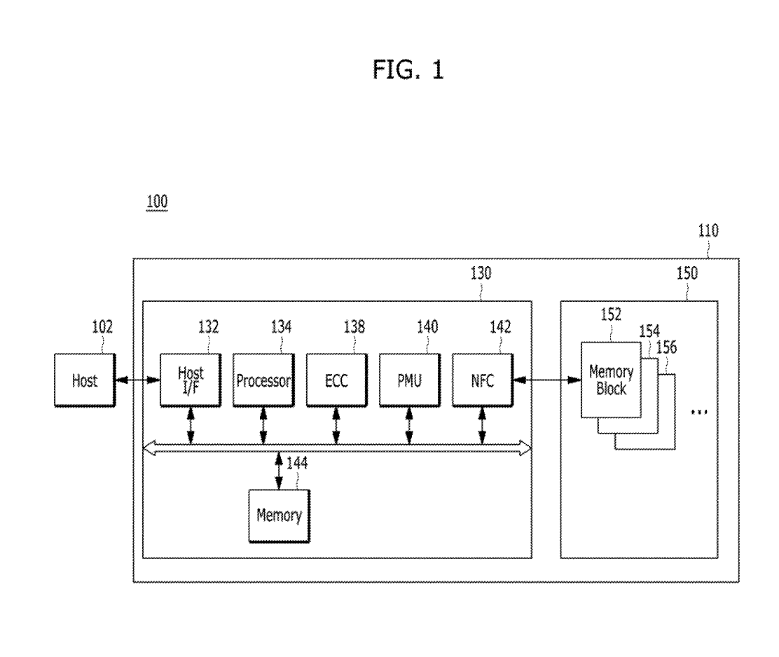

Referring now to FIG. 1 a data processing system including a memory system is provided, according to an embodiment of the present invention.

According to the embodiment of FIG. 1, a data processing system 100 may include a host 102 and a memory system 110.

The host 102 may include, for example, a portable electronic device such as a mobile phone, an MP3 player and a laptop computer or an electronic device such as a desktop computer, a game player, a TV and a projector.

The memory system 110 may operate in response to a request from the host 102, and in particular, store data to be accessed by the host 102. In other words, the memory system 110 may be used as a main memory system or an auxiliary memory system of the host 102, The memory system 110 may be implemented with any one of various kinds of storage devices, according to the protocol of a host interface to be electrically coupled with the host 102. The memory system 110 may be implemented with any one of various kinds of storage devices, such as, for example, a solid state drive (SSD), a multimedia card (MMC), an embedded MMC (eMMC), a reduced size MMC (RS-MMC) and a micro-MMC, a secure digital (SD) card, a mini-SD and a micro-SD, a universal serial bus (USB) storage device, a universal flash storage (UFS) device, a compact flash (CF) card, a smart media (SM) card, a memory stick, and the like,

The storage devices for the memory system 110 may be implemented with a volatile memory device such as a dynamic random access memory (DRAM) and a static random access memory (SRAM) or a nonvolatile memory device, such as, for example, a read only memory (ROM), a mask ROM (MROM), a programmable ROM (PROM), an erasable programmable ROM (EPROM), an electrically erasable programmable ROM (EEPROM), a ferroelectric random access memory (FRAM), a phase change RAM (PRAM), a magnetoresistive RAM (MRAM) and a resistive RAM (RRAM).

The memory system 110 may include a memory device 150 which stores data to be accessed by the host 102, and a controller 130 which may control storage of data in the memory device 150.

The controller 130 and the memory device 150 may be integrated into one semiconductor device. For instance, the controller 130 and the memory device 150 may be integrated into one semiconductor device configured as a solid state drive (SSD). When the memory system 110 is used as the SSD, the operation speed of the host 102 that is electrically coupled with the memory system 110 may be significantly increased.

The controller 130 and the memory device 150 may be integrated into one semiconductor device configured as a memory card, such as, for example, a Personal Computer Memory Card International Association (PCMCIA) card, a compact flash (CF) card, a smart media (SM) card (SMC), a memory stick, a multimedia card (MMC) an RS-MMC and a micro-MMC, a secure digital (SD) card, a mini-SD, a micro-SD and an SDHC, and a universal flash storage (UFS) device.

For another instance, the memory system 110 may be configured as a computer, an ultra-mobile PC (UMPC), a workstation, a net-book, a personal digital assistant (PDA), a portable computer, a web tablet, a tablet computer, a wireless phone, a mobile phone, a smart phone, an e-book, a portable multimedia player (PMP), a portable game player, a navigation device, a black box, a digital camera, a digital multimedia broadcasting (DMB) player, a three-dimensional (3D) television, a smart television, a digital audio recorder, a digital audio player, a digital picture recorder, a digital picture player, a digital video recorder, a digital video player, a storage configuring a data center, a device capable of transmitting and receiving information under a wireless environment, one of various electronic devices configuring a home network, one of various electronic devices configuring a computer network, one of various electronic devices configuring a telematics network, an RFID device, or one of various component elements configuring a computing system.

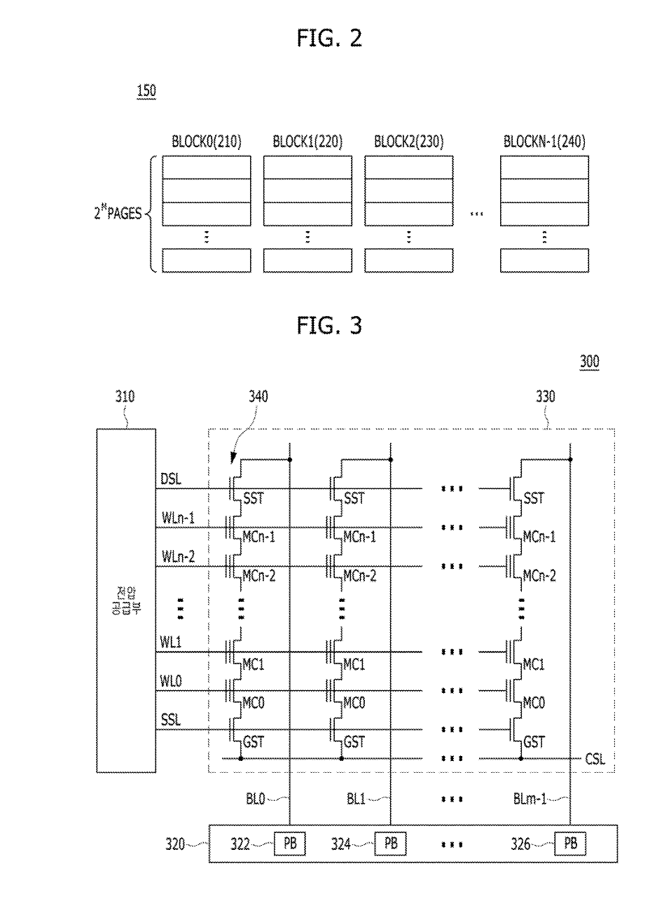

The memory device 150 of the memory system 110 may retain stored data when power supply is interrupted and, in particular, store the data provided from the host 102 during a write operation, and provide stored data to the host 102 during a read operation. The memory device 150 may include a plurality of memory blocks 152, 154 and 156. Each of the memory blocks 152, 154 and 156 may include a plurality of pages. Each of the pages may include a plurality of memory cells to which a plurality of word lines (WL) are electrically coupled. The memory device 150 may be a nonvolatile memory device, for example, a flash memory. The flash memory may have a three-dimensional (3D) stack structure. The structure of the memory device 150 and the three-dimensional (3D) stack structure of the memory device 150 will be described later in detail with reference to FIGS. 2 to 11.

The controller 130 of the memory system 110 may control the memory device 150 in response to a request from the host 102. The controller 130 may provide the data read from the memory device 150, to the host 102, and store the data provided from the host 102 into the memory device 150. To this end, the controller 130 may control overall operations of the memory device 150, such as read, write, program and erase operations.

In detail, the controller 130 may include a host interface unit 132, a processor 134, an error correction code (ECC) unit 138, a power management unit 140, a NAND flash controller 142, and a memory 144.

The host interface unit 132 may process commands and data provided from the host 102, and may communicate with the host 102 through at least one of various interface protocols, such as, for example, universal serial bus (USB), multimedia card (MMC), peripheral component interconnect-express (PCI-E), serial attached SCSI (SAS) serial advanced technology attachment (SATA) parallel advanced technology attachment (PATA), small computer system interface (SCSI), enhanced small disk interface (ESDI), and integrated drive electronics (IDE).

The ECC unit 138 may detect and correct errors in the data read from the memory device 150 during the read operation. The ECC unit 138 may not correct error bits when the number of the error bits is greater than or equal to a threshold number of correctable error bits, and may output an error correction fail signal indicating failure in correcting the error bits.

The ECC unit 138 may perform an error correction operation based on a coded modulation such as a low density parity check (LDPC) code, a Bose-Chaudhuri-Hocquenghem (BCH) code, a turbo code, a Reed-Solomon (RS) code, a convolution code, a recursive systematic code (RSC), a trellis-coded modulation (TCM), a Block coded modulation (BCM), and so on. The ECC unit 138 may include all circuits, systems or devices needed for the error correction operation.

The PMU 140 may provide and manage power for the controller 130, that is, power for the component elements included in the controller 130.

The NFC 142 may serve as a memory interface between the controller 130 and the memory device 150 to allow the controller 130 to control the memory device 150 in response to a request from the host 102. The NFC 142 may generate control signals for the memory device 150 and process data under the control of the processor 134 when the memory device 150 is a flash memory and, in particular, when the memory device 150 is a NAND flash memory,

The memory 144 may serve as a working memory of the memory system 110 and the controller 130, and store data for driving the memory system 110 and the controller 130. The controller 130 may control the memory device 150 in response to a request from the host 102. For example, the controller 130 may provide the data read from the memory device 150 to the host 102 and store the data provided from the host 102 in the memory device 150. When the controller 130 controls the operations of the memory device 150, the memory 144 may store data used by the controller 130 and the memory device 150 for such operations as read, write, program and erase operations.

The memory 144 may be implemented with a volatile memory. The memory 144 may, for example, be implemented with a static random access memory (SRAM) or a dynamic random access memory (DRAM). As described above, the memory 144 may store data used by the host 102 and the memory device 150 for the read and write operations. To store the data, the memory 144 may include a program memory, a data memory, a write buffer, a read buffer, map buffer and so forth.

The processor 134 may control general operations of the memory system 110, and a write operation or a read operation for the memory device 150, in response to a write request or, a read request from the host 102. The processor 134 may drive firmware which is referred to as a flash translation layer (FTL), to control the general operations of the memory system 110. The processor 134 may be implemented with a microprocessor or a central processing unit (CPU).

A management unit (not shown) may be included in the processor 134, and may perform bad block management of the memory device 150. The management unit may find bad memory blocks, which are in unsatisfactory condition for further use, and perform bad block management on the bad memory blocks. When the memory device 150 is a flash memory, for example, a NAND flash memory, a program failure may occur during the write operation, for example, during the program operation, due to characteristics of a NAND logic function. During the bad block management, the data of the program-failed memory block or the bad memory block may be to programmed into a new memory block. Also, the bad blocks due to the program fail seriously deteriorates the utilization efficiency of the memory device 150 having a 3D stack structure and the reliability of the memory system 100, and thus reliable bad block management is required.

FIG. 2 is a schematic diagram illustrating the memory device 150 shown in FIG. 1.

According to the embodiment of FIG. 2, the memory device 150 may include a plurality of memory blocks, for example zeroth to (N-1)^{th} blocks 210 to 240. Each of the plurality of memory blocks 210 to 240 may include a plurality of pages, for example, 2^{M} number of pages (2^{M} PAGES), to which the present invention will not be limited. Each of the plurality of pages may include a plurality of memory cells to which a plurality of word lines are electrically coupled.

Also, the memory device 150 may include a plurality of memory blocks as single level cell (SLC) memory blocks and multi-level cell (MLC) memory blocks, according to the number of bits which may be stored or expressed in each memory cell. The SLC memory block may include a plurality of pages which are implemented with memory cells each capable of storing 1-bit data. The MLC memory block may include a plurality of pages which are implemented with memory cells each capable of storing multi-bit data, for example, two or more-bit data. An MLC memory block including a plurality of pages which are implemented with memory cells that are each capable of storing 3-bit data may be defined as a triple level cell (TLC) memory block.

Each of the plurality of memory blocks 210 to 240 may store the data provided from the host device 102 during a write operation, and may provide stored data to the host 102 during a read operation.

FIG. 3 is a circuit diagram illustrating one of the plurality of memory blocks 152 to 156 shown in FIG. 1.

According to the embodiment of FIG. 3, the memory block 152 of the memory device 150 may include a plurality of cell strings 340 which are electrically coupled to bit lines BL0 to BLm-1, respectively. The cell string 340 of each column may include at least one drain select transistor DST and at least one source select transistor SST. A plurality of memory cells or a plurality of memory cell transistors MC0 to MCn-1 may be electrically coupled in series between the select transistors DST and SST. The respective memory cells MC0 to MCn-1 may be configured by multi-level cells (MLC) each of which stores data information of a plurality of bits. The strings 340 may be electrically coupled to the corresponding bit lines BL0 to BLm-1, respectively. For reference, in FIG. 3, ‘DSL’ denotes a drain select line, ‘SSL’ denotes a source select line, and ‘CSL’ denotes a common source line.

While FIG. 3 shows, as an example, the memory block 152 which is configured by NAND flash memory cells, it is to be noted that the memory block 152 of the memory device 150 according to the embodiment is not limited to NAND flash memory and may be realized by NOR flash memory, hybrid flash memory in which at least two kinds of memory cells are combined, or one-NAND flash memory in which a controller is built in a memory chip. The operational characteristics of a semiconductor device may be applied to not only a flash memory device in which a charge storing layer is configured by conductive floating gates but also a charge trap flash (CTF) in which a charge storing layer is configured by a dielectric layer.

A voltage supply block 310 of the memory device 150 may provide word line voltages, for example, a program voltage, a read voltage and a pass voltage, to be supplied to respective word lines according to an operation mode and voltages to be supplied to bulks, for example, well regions in which the memory cells are formed. The voltage supply block 310 may perform a voltage generating operation under the control of a control circuit (not shown). The voltage supply block 310 may generate a plurality of variable read voltages to generate a plurality of read data, select one of the memory blocks or sectors of a memory cell array under the control of the control circuit, select one of the word lines of the selected memory block, and provide the word line voltages to the selected word line and unselected word lines.

A read/write circuit 320 of the memory device 150 may be controlled by the control circuit, and may serve as a sense amplifier or a write driver according to an operation mode. During a to verification/normal read operation, the read/write circuit 320 may serve as a sense amplifier for reading data from the memory cell array. Also, during a program operation, the read/write circuit 320 may serve as a write driver which drives bit lines according to data to be stored in the memory cell array. The read/write circuit 320 may receive data to be written in the memory cell array, from a buffer (not shown), during the program operation and may drive the bit lines according to the inputted data. To this end, the read/write circuit 320 may include a plurality of page buffers 322 324 and 326 respectively corresponding to columns (or bit lines) or pairs of columns (or pairs of bit lines), and a plurality of latches (not shown) may be included in each of the page buffers 322, 324 and 326.

FIGS, 4 to 11 are schematic diagrams illustrating the memory device 150 shown in FIG. 1.

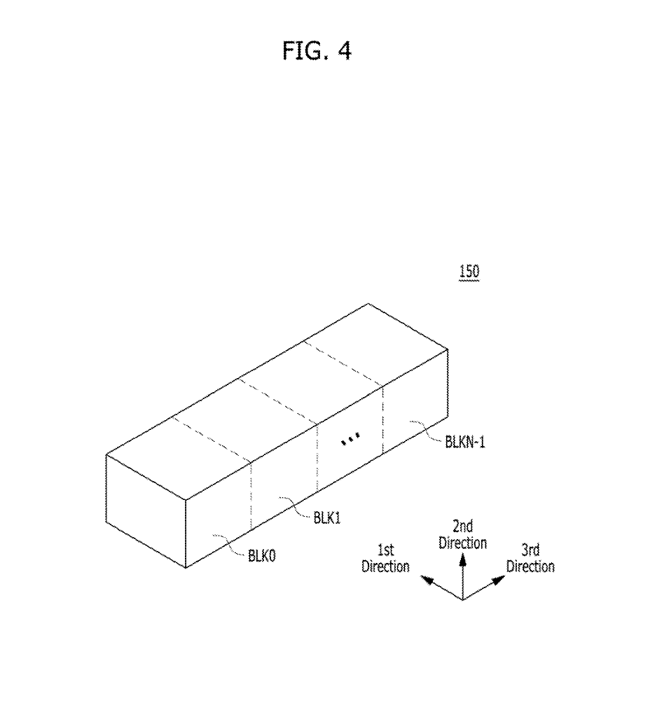

FIG. 4 is a block diagram illustrating an example of the plurality of memory blocks 152 to 156 of the memory device 150 shown in FIG. 1,

According to the embodiment of FIG. 4, the memory device 150 may include a plurality of memory blocks BLK0 to BLKN-1, and each of the memory blocks BLK0 to BLKN-1 may be realized in a three-dimensional (3D) structure or a vertical structure. The respective memory blocks BLK0 to BLKN-1 may include structures which extend in first to third directions, for example, an x-axis direction, a y-axis direction and a z-axis direction,

The respective memory blocks BLK0 to BLKN-1 may include a plurality of NAND strings NS which extend in the second direction. The plurality of NAND strings NS may be provided in the first direction and the third direction. Each NAND string NS may be electrically coupled to a bit line BL, at least one source select line SSL, at least one ground select line GSL, a plurality of word lines WL atleast one dummy word line DWL and a common source line CSL. Namely, the respective memory blocks BLK0 to BLKN-1 may be electrically coupled to a plurality of bit lines BL, a plurality of source select lines SSL, a plurality of ground select lines GSL, a plurality of word lines WL a plurality of dummy word lines DWL, and a plurality of common source lines CSL.

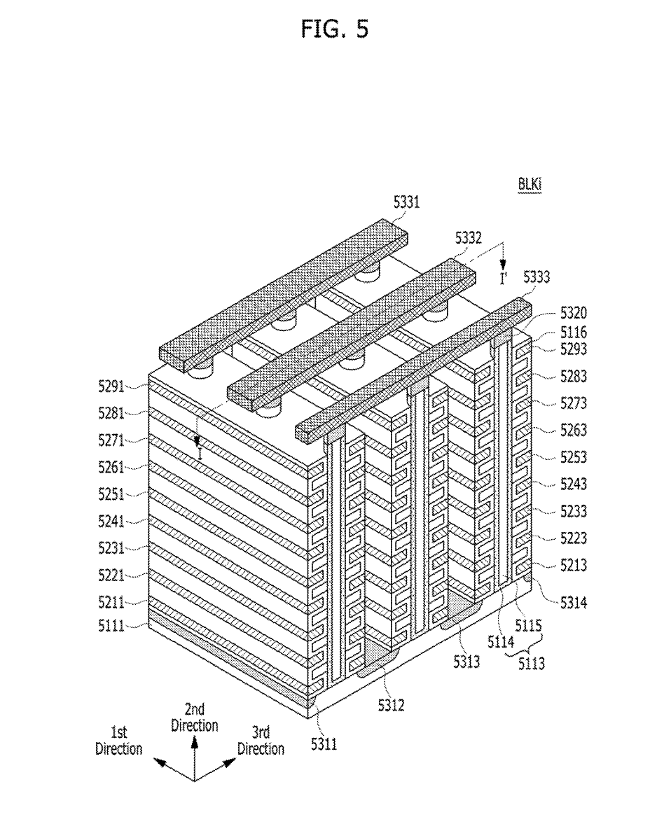

FIG. 5 is a perspective view of one BLKi of the plural memory blocks BLK0 to BLKN-1 shown in FIG. 4. FIG. 5 is a cross-sectional view taken along a line I-I′ (of the memory block BLKi shown in FIG. 5.

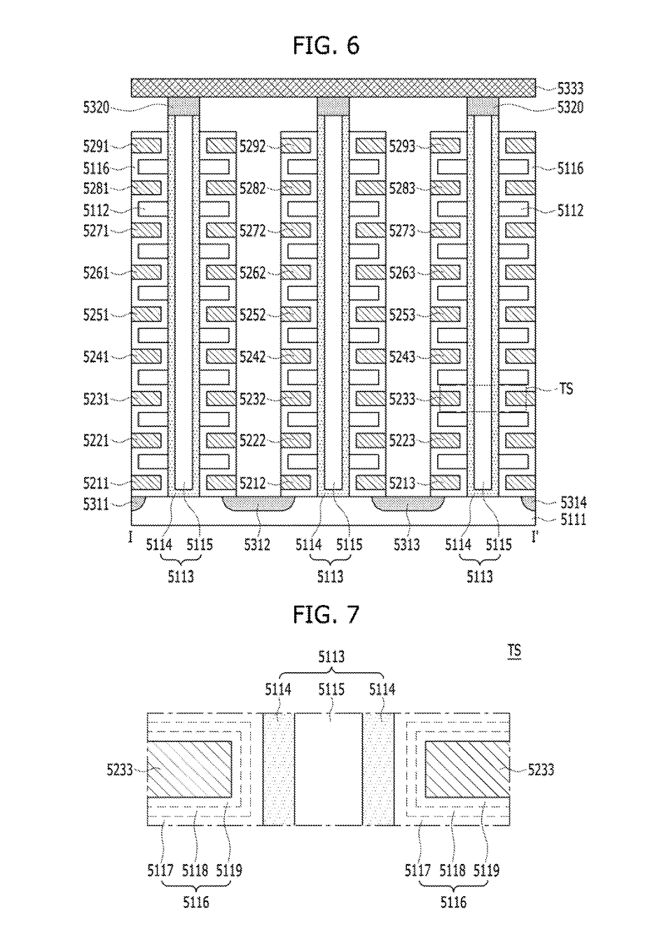

According to the embodiment of FIGS. 5 and 6, a memory block BLKi among the plurality of memory blocks of the memory device 150 may include a structure which extends in the first to third directions.

A substrate 5111 may be provided. The substrate 5111 may include a silicon material doped with a first type impurity. The substrate 5111 may include a silicon material doped with a p-type impurity or may be a p-type well, for example, a pocket p-well, and include an n-type well which surrounds the p-type well. While it is assumed that the substrate 5111 is p-type silicon, it is to be noted that the substrate 5111 is not limited to being p-type silicon.

A plurality of doping regions 5311 to 5314 which extend in the first direction may be provided over the substrate 5111. The plurality of doping regions 5311 to 5314 may contain a second type of impurity that is different from the substrate 5111. The plurality of doping regions 5311 to 5314 may be doped with an n-type impurity. While it is assumed here that first to fourth doping regions 5311 to 5314 are n-type it is to be noted that the first to fourth doping regions 5311 to 5314 are not limited to being n-type.

In the region over the substrate 5111 between the first and second doping regions 5311 and 5312, a plurality of dielectric materials 5112 which extend in the first direction may be sequentially provided in the second direction. The dielectric materials 5112 and the substrate 5111 may be separated from one another by a predetermined distance in the second direction. The dielectric materials 5112 may be separated from one another by a predetermined distance in the second direction. The dielectric materials 5112 may include a dielectric material such as silicon oxide.

In the region over the substrate 5111 between the first and second doping regions 5311 and 5312, a plurality of pillars 5113 which are sequentially disposed in the first direction and pass through the dielectric materials 5112 in the second direction may be provided. The plurality of pillars 5113 may respectively pass through the dielectric materials 5112 and may be electrically coupled with the substrate 5111. Each pillar 5113 may be configured by a plurality of materials. The surface layer 5114 of each pillar 5113 may include a silicon material doped with the first type of impurity. The surface layer 5114 of each pillar 5113 may include a silicon material doped with the same type of impurity as the substrate 5111. While it is assumed here that the surface layer 5114 of each pillar 5113 may include p-type silicon the surface layer 5114 of each pillar 5113 is not limited to being p-type silicon.

An inner layer 5115 of each pillar 5113 may be formed of a dielectric material. The inner layer 5115 of each pillar 5113 may be filled by a dielectric material such as silicon oxide.

In the region between the first and second doping regions 5311 and 5312, a dielectric layer 5116 may be provided along the exposed surfaces of the dielectric materials 5112, the pillars 5113 and the substrate 5111. The thickness of the dielectric layer 5116 may be less than half of the distance between the dielectric materials 5112. In other words, a region in which a material other than the dielectric material 5112 and the dielectric layer 5116 may be disposed, may be provided between (i) the dielectric layer 5116 provided over the bottom surface of a first dielectric material of the dielectric materials 5112 and (ii) the dielectric layer 5116 provided over the top surface of a second dielectric material of the dielectric materials 5112. The dielectric materials 5112 lie below the first dielectric material.

In the region between the first and second doping regions 5311 and 5312, conductive materials 5211 to 5291 may be provided over the exposed surface of the dielectric layer 5116. The conductive material 5211 which extends in the first direction may be provided between the dielectric material 5112 adjacent to the substrate 5111 and the substrate 5111. In particular, the conductive material 5211 which extends in the first direction may be provided between (i) the dielectric layer 5116 disposed over the substrate 5111 and (ii) the dielectric layer 5116 disposed over the bottom surface of the dielectric material 5112 adjacent to the substrate 5111,

The conductive material which extends in, the first direction may be provided between (i) the dielectric layer 5116 disposed over the top surface of one of the dielectric material is 5112 and (ii) the dielectric layer 5116 disposed over the bottom surface of another dielectric material of the dielectric materials 5112, which is disposed over the certain dielectric material 5112. The conductive materials 5221 to 5281 which extend in the first direction may be provided between the dielectric materials 5112. The conductive material 5291 which extends in the first direction may be provided over the uppermost dielectric material 5112. The conductive materials 5211 to 5291 which extend in the first direction may be a metallic material. The conductive materials 5211 to 5291 which extend in the first direction may be a conductive material such as polysilicon.

In the region between the second and third doping regions 5312 and 5313, the same structures as the structures between the first and second doping regions 5311 and 5312 may be provided. For example, in the region between the second and third doping regions 5312 and 5313, the plurality of dielectric materials 5112 which extend in the first direction, the plurality of pillars 5113 which are sequentially arranged in the first direction and pass through the plurality of dielectric materials 5112 in the second direction, the dielectric layer 5116 which is provided over the exposed surfaces of the plurality of dielectric materials 5112 and the plurality of pillars 5113 and the plurality of conductive materials 5212 to 5292 which extend in the first direction may be provided.

In the region between the third and fourth doping regions 5313 and 5314, the same structures as between the first and second doping regions 5311 and 5312 may be provided. For example, in the region between the third and fourth doping regions 5313 and 5314, the plurality of d electric materials 5112 which extend in the first direction, the plurality of pillars 5113 which are sequentially arranged in the first direction and pass through the plurality of dielectric materials 5112 in the second direction, the dielectric layer 5116 which is provided over the exposed surfaces of the plurality of dielectric materials 5112 and the plurality of pillars 5113, and the plurality of conductive materials 5213 to 5293 which extend in the first direction may be provided.

Drains 5320 may be respectively provided over the plurality of pillars 5113. The drains 5320 may be silicon materials doped with second type impurities. The drains 5320 may be silicon materials doped with n-type impurities. While it is assumed for the sake of convenience that the drains 5320 include n-type silicon, it is to be noted that the drains 5320 are not limited to being n-type silicon. For example, the width of each drain 5340 may be larger than the width of each corresponding pillar 5113. Each drain 5320 may be provided in the shape of a pad over the top surface, of each corresponding pillar 5113.

Conductive materials 5331 to 5333 which extend in the third direction may be provided over the drains 5320. The conductive materials 5331 to 5333 may be sequentially disposed in the first direction. The respective conductive materials 5331 to 5333 may be electrically coupled with the drains 5320 of corresponding regions. The drains 5320 and the conductive materials 5331 to 5333 which extend in the third direction may be electrically coupled with through contact plugs. The conductive materials 5331 to 5333 which extend in the third direction may be a metallic material. The conductive materials 5331 to 5333 which extend in the third direction may be a conductive material such as polysilicon,

In FIGS. 5 and 6, the respective pillars 5113 may form strings together with the dielectric layer 5116 and the conductive materials 5211 to 5291, 5212 to 5292 and 5213 to 5293 which extend in the first direction. The respective pillars 5113 may form NAND strings NS together with the dielectric layer 5116 and the conductive materials 5211 to 5291, 5212 to 5292 and 5213 to 5293 which extend in the first direction. Each NAND string NS may include a plurality of transistor structures TS.

FIG. 7 is a cross-sectional view of the transistor structure TS shown in FIG. 6.

According to the embodiment of FIG. 7, in the transistor structure TS shown in FIG. 6, the dielectric layer 5116 may include first to third sub dielectric layers 5117, 5118 and 5119.

The surface layer 5114 of p-type silicon in each of the pillars 5113 may serve as a body. The first sub dielectric layer 5117 adjacent to the pillar 5113 may serve as a tunneling dielectric layer, and may Include a thermal oxidation layer.

The second sub dielectric layer 5118 may serve as a charge storing layer. The second sub dielectric layer 5118 may serve as a charge capturing layer, and may include a nitride layer or a metal oxide layer such as an aluminum oxide layer, a hafnium oxide layer, or the like.

The third sub dielectric layer 5119 adjacent to the conductive material 5233 may serve as a blocking dielectric layer. The third sub dielectric layer 5119 adjacent to the conductive material 5233 which extends in the first direction may be formed as a single layer or multiple layers. The third sub dielectric layer 5119 may be a high-k dielectric layer such as an aluminum oxide layer, a hafnium oxide layer, or the like, which has a dielectric constant greater than the first and second sub dielectric layers 5117 and 5118.

The conductive material 5233 may serve as a gate or a control gate. That is, the gate or the control gate 5233, the blocking dielectric layer 5119, the charge storing layer 5118, the tunneling dielectric layer 5117 and the body 5114 may form a transistor or a memory cell transistor structure. For example, the first to third sub dielectric layers 5117 to 5119 may form an oxide-nitride-oxide (ONO) structure. In the embodiment, for the sake of convenience, the surface layer 5114 of p-type silicon in each of the pillars 5113 will be referred to as a body in the second direction

The memory block BLKi may include the plurality of pillars 5113. Namely, the memory block BLKi may include the plurality of NAND strings NS. In detail, the memory block BLKi may include the plurality of NAND strings NS which extend in the second direction or a direction perpendicular to the substrate 5111.

Each NAND string NS may include the plurality of transistor structures TS which are disposed in the second direction. At least one of the plurality of transistor structures TS of each NAND string NS may serve as a string source transistor SST. At least one of the plurality of transistor structures TS of each NAND string NS may serve as a ground select transistor GST.

The gates or control gates may correspond to the conductive materials 5211 to 5291, 5212 to 5292 and 5213 to 5293 which extend in the first direction. In other words, the gates or the control gates may extend in the first direction and form word lines and at least two select lines, at least one source select line SSL and at least one ground select line GSL.

The conductive materials 5331 to 5333 which extend in the third direction may be electrically coupled to one end of the NAND strings NS. The conductive materials 5331 to 5333 which extend in the third direction may serve as bit lines BL. That is, in one memory block BLKi, the plurality of NAND strings NS may be electrically coupled to one bit line BL.

The second type doping regions 5311 to 5314 which extend in the first direction may be provided to the other ends of the NAND strings NS. The second type doping regions 5311 to 5314 which extend in the first direction may serve as common source lines CSL.

Namely, the memory block BLKi may include a plurality of NAND strings NS which extend in a direction perpendicular to the substrate 5111, e,g,, the second direction, and may serve as a NAND flash memory block, for example, of a charge capturing type memory, in which a plurality of NAND strings NS are electrically coupled to one bit line BL.

While it is illustrated in FIGS. 5 to 7 that the conductive materials 5211 to 5291, 5212 to 5292 and 5213 to 5293 which extend in the first direction are provided in 9 layers, it is to be noted that the conductive materials 5211 to 5291, 5212 to 5292 and 5213 to 5293 which extend in the first direction are not limited to being provided in 9 layers. For example, conductive materials which extend in the first direction may be provided in 8 layers, 16 layers or any multiple of layers. In other words, in one NAND string NS, the number of transistors may be 8, 16 or more.,

While it is illustrated in FIGS. 5 to 7 that 3 NAND strings NS are electrically coupled to one bit line BL, it, is to be noted that the embodiment is not limited to having 3 NAND strings NS that are electrically coupled to one bit line BL. In the memory block BLKi, m number of NAND strings NS may be electrically coupled to one bit line BL, m being a positive integer. According to the number of NAND strings NS which are electrically coupled to one bit line BL, the number of conductive materials 5211 to 5291, 5212 to 5292 and 5213 to 5293 which extend in the first direction and the number of common source lines 5311 to 5314 may be controlled as well.

Further, while it is illustrated in FIGS. 5 to 7 that 3 NAND strings NS are electrically coupled to one conductive material which extends in the first direction, it is to be noted that the embodiment is not limited to having 3 NAND strings NS electrically coupled to one conductive material which extends in the first direction. For example, n number of NAND strings NS may be electrically coupled to one conductive material which extends in the first direction, n being a to positive integer. According to the number of NAND strings NS which are electrically coupled to one conductive material which extends in the first direction, the number of bit lines 5331 to 5333 may be controlled as well.

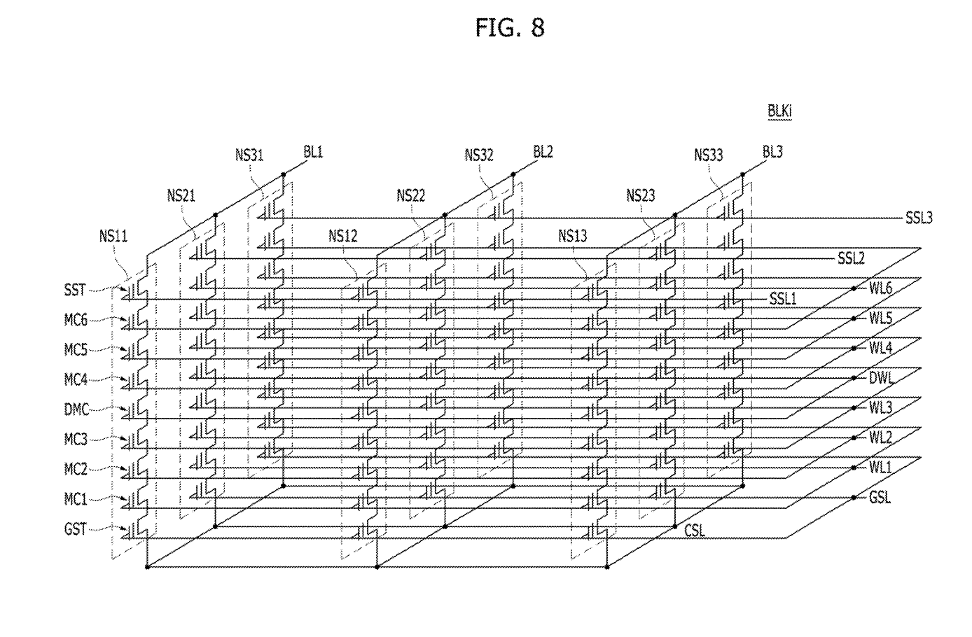

FIG. 8 is an equivalent circuit diagram illustrating the memory block BLKi having a first structure described with reference to FIGS. 5 to 7.

According to the embodiment of FIG. 8, in a block BLKi having the first structure, NAND strings NS11 to NS31 may be provided between a first bit line BL1 and a common source line CSL. The first bit line BL1 may correspond to the conductive material 5331 of FIGS. 5 and 6, which extends in the third direction. NAND strings NS12 to NS32 may be provided between a second bit line BL2 and the common source line CSL. The second bit line BL2 may correspond to the conductive material 5332 of FIGS. 5 and 6, which extends in the third direction. NAND strings NS13 to NS33 may be provided between a third bit line BL3 and the common source line CSL. The third bit line BL3 may correspond to the conductive material 5333 of FIGS. 5 and 6, which extends in the third direction.

A source select transistor SST of each NAND string NS may be electrically coupled to a corresponding bit line BL. A ground select transistor GST of each NAND string NS may be electrically coupled to the common source line CSL. Memory cells MC may be provided between the source select transistor SST and the ground select transistor GST of each NAND string NS.

In this example, NAND strings NS may be defined by units of rows and columns and NAND strings NS which are electrically coupled to one bit line may form one column. The NAND strings NS11 to NS31 which are electrically coupled to the first bit line BL1 may correspond to a first column, the NAND strings NS12 to NS32 which are electrically coupled to the second bit line BL2 may correspond to a second column, and the NAND strings NS13 to NS33 which are electrically coupled to the third bit line BL3 may correspond to a third column. NAND strings NS which are electrically coupled to one source select line SSL may form one row. The NAND strings NS11 to NS13 which are electrically coupled to a first source select line SSL1 may form a first row, the NAND strings NS21 to NS23 which are electrically coupled to a second source select line SSL2 may form a second row, and the NAND strings NS31 to NS33 which are electrically coupled to a third source select line SSL3 may form a third row.

In each NAND string NS, a height may be defined. In each NAND string NS, the height of a memory cell MC1 adjacent to the ground select transistor GST may have a value ‘1’. In each NAND string NS, the height of a memory cell may increase as the memory cell gets closer to the source select transistor SST when measured from the substrate 5111. In each NAND string NS, the height of a memory cell MC6 adjacent to the source select transistor SST may be 7.

The source select transistors SST of the NAND strings NS in the same row may share the source select line SSL. The source select transistors SST of the NAND strings NS in different rows may be respectively electrically coupled to the different source select lines SSL1, SSL2 and SSL3.

The memory cells at the same height in the NAND strings NS in the same row may share a word line WL. That is, at the same height, the word lines WL electrically coupled to the memory cells MC of the NAND strings NS in different rows may be>electrically coupled. Dummy memory cells DMC at the same height in the NAND strings NS of the same row may share a dummy word line DWL. Namely, at the same height or level, the dummy word lines DWL electrically coupled to the dummy memory cells DMC of the NAND strings NS in different rows may be electrically coupled.

The word lines WL or the dummy word lines DWL located at the same level or height or layer may be electrically coupled with one another at layers where the conductive materials 5211 to 5291, 5212 to 5292 and 5213 to 5293 which extend in the first direction may be provided. The conductive materials 5211 to 5291, 5212 to 5292 and 5213 to 5293 which extend in the first direction may be electrically coupled in common to upper layers through contacts. At the upper layers, the conductive materials 5211 to 5291, 5212 to 5292 and 5213 to 5293 which extend in the first direction may be electrically coupled. In other words, the ground select transistors GST of the NAND strings NS in the same row may share the ground select line GSL. Further, the ground select transistors GST of the NAND strings NS in different rows may share the ground select line GSL. That is, the NAND strings NS11 to NS13, N521 to NS23 and NS31 to NS33 may be electrically coupled to the ground select line GSL.

The common source line CSL may be electrically coupled to the NAND strings NS. Over the active regions and over the substrate 5111, the first to fourth doping regions 5311 to 5314 may be electrically coupled. The first to fourth doping regions 5311 to 5314 may be electrically coupled to an upper layer through contacts and, at the upper layer, the first to fourth doping regions 5311 to 5314 may be electrically coupled.

Namely, as shown in FIG. 8, the word lines WL of the same height or level may be electrically coupled. Accordingly, when a word line WL at a specific height is selected, all NAND strings NS which are electrically coupled to the word line WL may be selected. The NAND strings NS in different rows may be electrically coupled to different source select lines SSL. Accordingly, among the NAND strings NS electrically coupled to the same word line WL, by selecting one of the source select lines SSL1 to SSL3, the NAND strings NS in the unselected rows may be electrically isolated from the bit lines BL1 to BL3. In other words, by selecting one of the source select lines SSL1 to SSL3, a row of NAND strings NS may be selected. Moreover, by selecting one of the bit lines BL1 to BL3, the NAND strings NS in the selected rows may be selected in units of columns.

In each NAND string NS, a dummy memory cell DMC may be provided. In FIG. 8, the dummy memory cell DMC may be provided between a third memory cell MC3 and a fourth memory cell MC4 in each NAND string NS. That is, first to third memory cells MC1 to MC3 may be provided between the dummy memory cell DMC and the ground select transistor GST. Fourth to sixth memory cells MC4 to MC6 may be provided between the dummy memory cell DMC and the source select transistor SST. The memory cells MC of each NAND string NS may be divided into memory cell groups by the dummy memory cell DMC. In the divided memory cell groups, memory cells, for example, MC1 to MC3, adjacent to the ground select transistor GST may be referred to as a lower memory cell group, and memory cells, for example, MC4 to MC6, adjacent to the string select transistor SST may be referred to as an upper memory cell group.

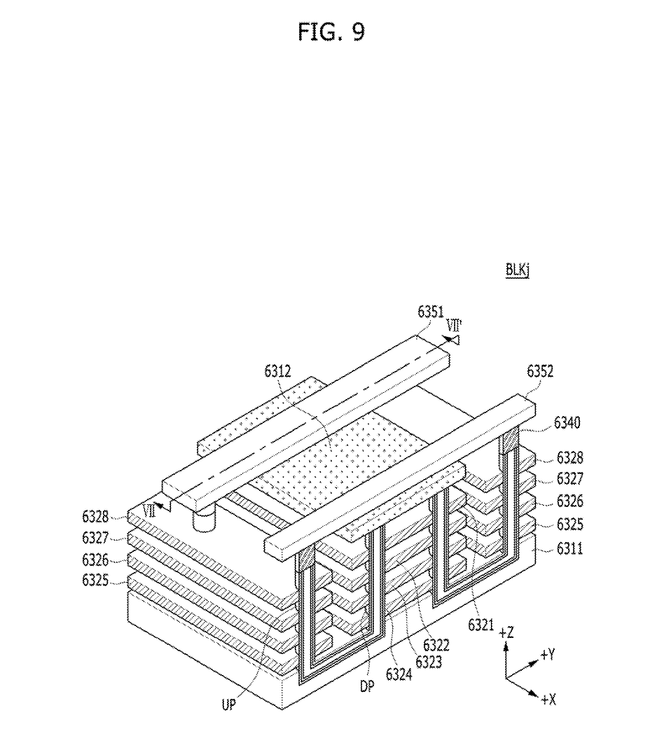

Hereinbelow, detailed descriptions will be made with reference to FIGS. 9 to 11, which show the memory device in the memory system according to an embodiment implemented with a three-dimensional (3D) nonvolatile memory device different from the first structure.

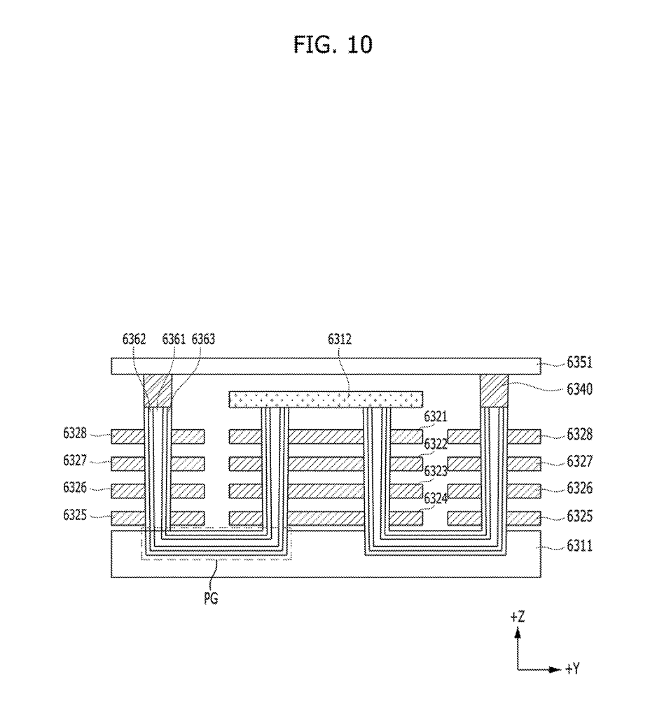

FIG. 9 is a perspective view schematically illustrating the memory device implemented with the three-dimensional (3D) nonvolatile memory device, which is different from the first structure described above with reference to FIGS. 5 to 8, and showing a memory block BLKj of the plurality of memory blocks of FIG. 4. FIG. 10 is a cross-sectional view illustrating the memory block BLKj taken along the line VII-VII′ of FIG. 9,

According to the embodiment of FIGS. 9 and 10, the memory block BLKj among the plurality of memory blocks of the memory device 150 of FIG. 1 may include structures which extend in the first to third directions.

A substrate 6311 may be provided. For example, the substrate 6311 may include a silicon material doped with a first type impurity. For example, the substrate 631 may may include a silicon material doped with a p-type impurity or may be a p-type well, for example, a pocket p-well, and include an n-type well which surrounds the p-type well. While it is assumed in the embodiment for the sake of convenience that the substrate 6311 is p-type silicon, it is to be noted that the substrate 6311 is not limited to being p-type silicon.

First to fourth conductive materials 6321 to 6324 which extend in the x-axis direction and the y-axis direction are provided over the substrate 6311. The first to fourth conductive materials 6321 to 6324 may be separated by a predetermined distance in the z-axis direction.

Fifth to eighth conductive materials 6325 to 6328 which extend in the x-axis direction and the y-axis direction may be provided over the substrate 6311. The fifth to eighth conductive materials 6325 to 6328 may be separated by the predetermined to distance in the z-axis direction. The fifth to eighth conductive materials 6325 to 6328 may be separated from the first to fourth conductive materials 6321 to 6324 in the y-axis direction.

A plurality of lower pillars DP which pass through the first to fourth conductive materials 6321 to 6324 may be provided. Each lower pillar DP extends in the z-axis direction. Also, a plurality of upper pillars UP which pass through the fifth to eighth conductive materials 6325 to 6328 may be provided. Each upper pillar UP extends in the z-axis direction.

Each of the lower pillars DP and the upper pillars UP may include an internal material 6361, an intermediate layer 6362, and a surface layer 6363. The intermediate layer 6362 may serve as a channel of the cell transistor. The surface layer 6363 may include a blocking dielectric layer, a charge storing layer and a tunneling dielectric layer.

The lower pillar DP and the upper pillar UP may be electrically coupled through a pipe gate C. The pipe gate PG may be disposed in the substrate 6311. For instance, the pipe gate PG may include the same material as the lower pillar DP and the upper pillar UP.

A doping material 6312 of a second type which extends in the x-axis direction and the y-axis direction may be provided over the lower pillars DP. For example, the doping material 6312 of the second type may include an n-type silicon material. The doping material 6312 of the second type may serve as a common source line CSL.

Drains 6340 may be provided over the upper pillars UP. The drains 6340 may include an n-type silicon material. First and second upper conductive materials 6351 and 6352 which extend in the y-axis direction may be provided over the drains 6340.

The first and second upper conductive materials 6351 and 6352 may be separated in the x-axis direction. The first and second upper conductive materials 6351 and 6352 may be formed of a metal. The first and second upper conductive materials 6351 and 6352 and the drains 6340 may be electrically coupled through contact plugs. The first and second upper conductive materials 6351 and 6352 respectively serve as first and second bit lines BL1 and BL2.

The first conductive material 6321 may serve as a source select line SSL, the second conductive material 6322 may serve as a first dummy word line DWL1, and the third and fourth conductive materials 6323 and 6324 serve as first and second main word lines MWL1, and MWL2, respectively. The fifth and sixth conductive materials 6325 and 6326 serve as third and fourth main word lines MWL3 and MWL4, respectively, the seventh conductive material 6327 may serve as a second dummy word line DWL2, and the eighth conductive material 6328 may serve as a drain select line DSL.

The lower pillar DP and the first to fourth conductive materials 6321 to 6324 adjacent to the lower pillar DP form a lower string. The upper pillar UP and the fifth to eighth conductive materials 6325 to 6328 adjacent to the upper pillar UP form an upper string. The lower string and the upper string may be electrically coupled through the pipe gate PG. One end of the lower string may be electrically coupled to the doping material 6312 of the second type which serves as the common source line CSL. One end of the upper string may be electrically coupled to a corresponding bit line through the drain 6340. One lower string and one upper string form one cell string which is electrically coupled between the doping material 6312 of the second type serving as the common source line CSL and a corresponding one of the upper conductive material layers 6351 and 6352 serving as the bit line BL.

That is, the lower string may include a source select transistor SST, the first dummy memory cell DMC1, and the first and second main memory cells MMC1 and MMC2. The upper string may include the third and fourth main memory cells MMC3 and MMC4, the second dummy memory cell DMC2, and a drain select transistor DST.

In FIGS, 9 and 10, the upper string and the lower string may form a NAND string NS, and the NAND string NS may include a plurality of transistor structures TS. Since the transistor structure included in the NAND string NS In FIGS, 9 and 10 is described above in detail with reference to FIG. 7, a detailed description thereof will be omitted herein.

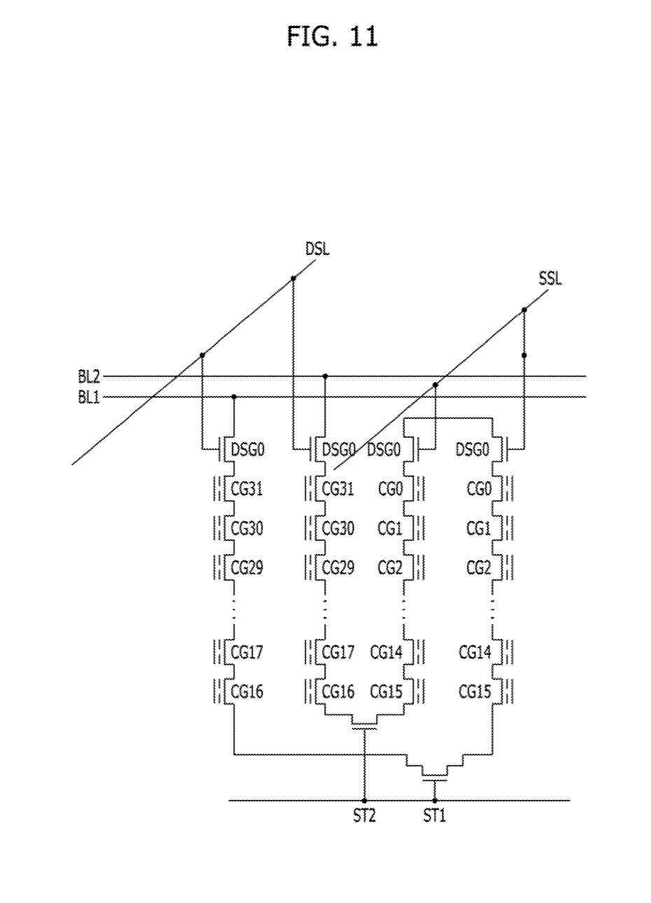

FIG. 11 is a circuit diagram illustrating the equivalent circuit of the memory block BLKj having the second structure as described above with reference to FIGS. 9 and 10. For the sake of convenience, only a first string and a second string, which form a pair in the memory block BLKj in the second structure are shown,

According to the embodiment of FIG. 11, in the memory block BLKj having the second structure among the plurality of blocks of the memory device 150, cell strings, each of which is implemented with one upper string and one: lower string electrically coupled through the pipe gate PG as described above with reference to FIGS. 9 and 10, may be provided in such a way as to define a plurality of pairs.

Namely, in the certain memory block BLKj having the second structure, memory cells CG0 to CG31 stacked along a first channel CH1 (not shown), for example, at least one source select gate SSG1 and at least one drain select gate DSG1 may form a first string ST1, and memory cells CG0 to CG31 stacked along a second channel CH2 (not shown), for example, at least one source select gate SSG2 and at least one drain select gate DSG2 may form a second string ST2.

The first string ST1 and the second string ST2 may be electrically coupled to the same drain select line DSL and the same source select line SSL The first string ST1 may be electrically coupled to a first bit: line BL1, and the second string ST2 may be electrically coupled to a second bit line

While it is described in FIG. 11 that the first string ST1 and the second string ST2 are electrically coupled to the same drain select line DSL and the same source select line SSL, it may be envisaged that the first string ST1 and the second string ST2 may be electrically coupled to the same source select line SSL and the same bit line BL, the first string ST1 may be electrically coupled to a first drain select line DSL1 and the second string ST2 may be electrically coupled to a second drain select line DSL2. Further it may be envisaged that the first string ST1 and the second string ST2 may be electrically coupled to the same drain select line DSL and the same bit line BL, the first string ST1 may be electrically coupled to a first source select line SSL1 and the second string ST2 may be electrically coupled a second source select line SSL2.

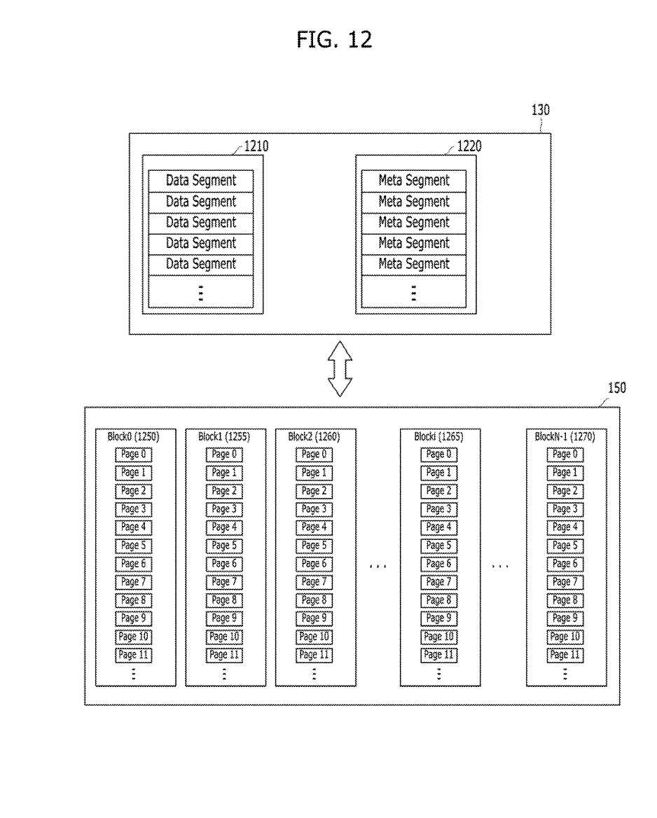

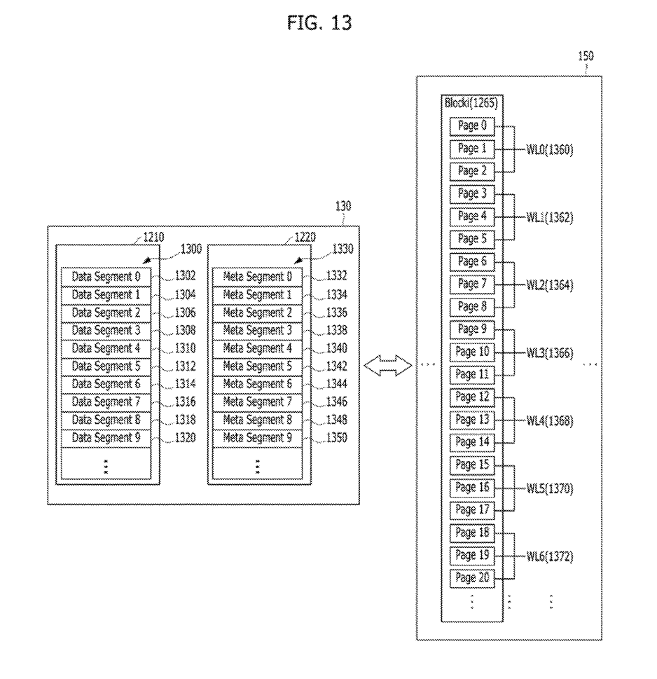

FIGS. 12 and 13 are diagrams for schematically describing an example of a command operation to a memory device in a memory system, according to an embodiment of the present inventions

When a sudden power-off occurs in the memory system 110 while the memory system 110 in the power-on state performs a program operation to an arbitrary page of one of the plurality of memory blocks, a process of managing the interrupted write data which is the object of the program operation which is interrupted due to the sudden power-off will be described in more detail

At a first time point, the memory system 110 may perform the program operation to a first page coupled to a first word line among the plurality of pages included in a selected memory block. At a second time point after the first time point, a sudden power-off may occur while the memory system 110 in the power-on state is performing the program operation by programming a write data to a second page coupled to a second word line among a plurality of pages included in the selected memory block. At a third time point after the second time point when the memory system 110 is powered on again, the memory system 110 may perform an erase operation to the second page for which the program operation was interrupted due to the sudden power-off. At a fourth time point after the third time point, the memory system 110 may resume the interrupted program operation of the second time point by restoring the interrupted write data, which was the object of the interrupted program operation of the second time point. The restoring step of the interrupted write data may be performed on the same page of the second time point, e.g., the second page.

The memory device 150 of the memory system 110 may include a plurality of memory blocks, for example memory blocks 1250 to 1270.

According to the embodiment of FIG. 12, the controller 130 may store user data corresponding to a trite command into a buffer included in the memory 144 of the controller 130, and program the user data stored in the buffer to at least one of the plurality of memory blocks 1250 to 1270.

Furthermore, the controller 130 may generate meta-data on the user data in response to the program operation for the user data, store the generated meta-data in the buffer 1220, and program the to meta-data stored in the buffer 1220 to at least one of the plurality of memory blocks 1250 to 1270. In an embodiment, the controller may program the meta-data stored in the buffer 1220 of the controller to one of the plurality of memory blocks 1250 to 1270. Buffer 1220 may be included in the memory 144 of the controller 130.

The controller 130 may store data segments of the user data in buffer 1210 serving as a data cache. The buffer 1210 may be included in the memory 144 of the controller 130. Then, the controller 130 may program the data segments stored in the buffer 1210 to at least one of the plurality of memory blocks 1250 to 1270. In an embodiment, the controller 130 may program the data segments stored in the buffer 1210 to one of the plurality of memory blocks 1250 to 1270.

Furthermore, the controller 130 may store meta-segments of the meta-data for the command operation and meta-segments of the meta-date for the user data of the command operation into buffer 1220 serving as a meta-cache. The buffer 1220 may be included in the memory 144 of the controller 130. Then the controller 130 may program the meta-segments stored in the buffer 1220 to at least one of the plurality of memory blocks 1250 to 1270L In an embodiment, the controller 130 may program the meta-segments stored in the buffer 1220 to one of the plurality of memory blocks 1250 to 1270.

In response to a read command, the controller 130 may check the meta-data for the user data in a memory block or the buffer 1220, to may read the user data from the corresponding memory block through the meta-data, and may provide the read user data to the host 102. At this time, the controller 130 may update the meta-segments for the read operation in response to the read operation, and store the updated meta-segments in the buffer 1200. Then, the controller 130 may program the meta-segments stored in the buffer 1200 to at least one of the plurality of memory blocks 1250 to 1270. In an embodiment, the controller 130 may program the meta-segments stored in the buffer 1200 to one of the plurality of memory blocks 250 to 1270.

In response to an erase operation, the controller 130 may check the meta-data for the erase operation in a memory block or the buffer 1220, perform the erase operation on the corresponding memory block through the meta-data, and convert the corresponding memory block into an open memory block. At this time, the controller 130 may update the meta-segments for the erase operation in response to the erase operation, and store the updated meta-data in the buffer 1220. Then the controller 130 may program the meta-segments stored in the buffer 1220 to at least one of the plurality of memory blocks 1250 to 1270. In an embodiment, the controller 130 may program the meta-segments stored in the buffer 1220 to one of the plurality of memory blocks 1250 to 1270.

The meta-data may include at least one information and data other than the user data. For example, the meta-data may include at least one of information on command data, information on a command operation, information on the memory blocks 1250 to 1270 to which the command operation is performed, and information such as map data corresponding to the command operation. In an embodiment, the meta-data may include all information and data stored in the controller other than the user data.

During a program operation, the controller 130 may store meta-data including first and second map data into one of the plurality of memory blocks 1250 to 1270. The first map data may include a logical to physical (L2P) map table of logical mapping information between logical addresses and physical addresses of the memory blocks storing the user data, and the second map data may include a Physical to Logical (P2L) map table of physical mapping information between physical addresses and logical addresses of the memory blocks storing the user data.

As the data segments of the user data are stored into the pages included in a least one of the memory blocks 1250 to 1270, the controller 130 may generate and store L2P segments of the first map data and P2L segments of the second map data for the user data in the buffer 1220.

The meta-data stored in the buffer 1220 may include at least one of command data information for the command data, command operation information for the command operation, memory block information for the memory block to which the command operation is performed, and the first and second map data.

Hereafter, an example, wherein the plurality of memory blocks 1250 to 1270 have a triple level cell (TLC) structure is provided. Specifically, each group of three pages among a plurality of pages included in respective memory blocks 1250 to 1270 may be coupled to a single word line, consecutive addresses may be allocated to each group of three pages, and data may be programmed into each group of three pages coupled to the single word line through one shot program will be taken as an example.

According to the embodiment of FIG. 13, when the controller 130 receives a write command from the host 102 and performs the program operation during a power-on state of the memory system 110, the controller 130 may store the data segments 1300 of the user data for the program operation in the buffer 1210 of the controller 130. The buffer 1210 may be included for example in the memory 144 of the controller 130.

For example, the data segments 1300 of the user data stored in the buffer 1210 may comprise at least ten data segments 1302 to 1320 DATA SEGMENT 0 to DATA SEGMENT 9 respectively corresponding to logical pages 0 to 9.

During a program operation in the power-on of the memory system 110, the controller 130 may store the meta-segments 1330 of the meta-data for the program operation (e.g., the meta-segments 1330 of the meta-data including map data for the user data) into the buffer 1220 of the controller 130. Buffer 1220 may be included in the memory 144 of the controller 130.

For example, the meta-segments 1330 stored in the buffer 220 may comprise at least ten meta-segments 1332 to 1350 META-SEGMENT 0 to META-SEGMENT 9 respectively corresponding to segment indexes 0 to 9 of the meta-data.

As described above with respect to the TLC structure, the controller 130 may program each three among the data segments 1300 and the meta-segments 1330 stored in the first and second buffers 1210 and 1220 respectively into each group of three pages coupled to a single word line among a plurality of pages in one (e.g., the “Block i” 1265 shown in FIG. 12) of the plurality of memory blocks 1250 to 1270 through the one shot program during the power-on of the memory system 110.

For example, at a first time point during the power-on b the memory system 110, the controller 130 may program three data segments 1302 to 1306 DATA SEGMENT 0 to 2 of the buffer 1210 into the Block i 1265 through the one shot program. For example, the Block i 1265 may include a plurality of pages of which each group of three pages are coupled to a single word line. In other words, the Block i 1265 may include a first group of three pages Page 0 to Page 2 coupled to the word line WL0, a second group of three pages Page 3 to Page 5 coupled to the word line WL1, a third group of three pages Page 6 to Page 8 coupled to the word line WL2, a fourth group of three pages Page 9 to Page 11 coupled to the word line WL3, a fifth group of three pages Page 12 to Page 14 coupled to the word line WL4, a sixth group of three pages Page 15 to Page 17 coupled to the word line WL5, and a seventh group of three pages Page 18 to Page 20 coupled to the word line WL6.

For example, the controller 130 may program three data segments 1302 to 1306 DATA SEGMENT 0 to DATA SEGMENT 2 of the buffer 1210 to the first group of three pages Page 0 to Page 2 coupled to the word line WL0 in the Block i 1265, respectively, through one shot program at the first time point during the power-on of the memory system 110.

At a second time point after the first time point during the power-on of the memory system 110, the sudden power-off may occur while the controller 130 is programming subsequent three data segments 1308 to 1312 DATA SEGMENT 3 to DATA SEGMENT 5 of the buffer 1210 to the subsequent second group of three pages Page 3 to Page 5 coupled to the word line WL1 in the Block i 1265, respectively, through the one shot program.

At a third time point after the second time point when the memory system 110 is powered on again, the controller 130 may check whether the program operation of the second time point is interrupted or is not normally ended due to the sudden power-off.

At the third time point of the power-on of the memory system 110, the controller 130 may check whether the program operation of the second time point is interrupted or the program operation for the three data segments 1308 to 1312 DATA SEGMENT 3 to DATA SEGMENT 5 of the buffer 1210 to the second group of three pages Page 3 to Page 5 coupled to the word line WL1 in the Block i 1265 is not normally ended due to the sudden power-off of the second time point.

As a result of the check of the interrupted program operation due to the sudden power-off, the controller 130 may perform an erase operation to the second group of three pages Page 3 to Page 5 coupled to the word line WL1 where the program operation is interrupted due to the sudden power-off at the second time point. Thus, the controller 130 may convert the interrupted pages Page 3 to Page 5 coupled to the word line WL1 into normal empty pages in the Block i 1265.

At a fourth time point after the third time point the controller 130 may resume the program operation to the second group of erased pages Page 3 to Page 5 of the third time point by restoring the three data segments 1308 to 1312 DATA SEGMENT 3 to DATA SEGMENT 5, which were the object of the interrupted program operation of the second time point. That is, the controller 130 may program the three data segments 1308 to 1312 DATA SEGMENT 3 to DATA SEGMENT 5 stored in the buffer 1210 to the second group of erased pages Page 3 to Page 5 coupled to the word line WL1 in the Block i 1265 through the one shot program at the fourth time point during the power-on of the memory system 110.

To sum up, when the memory system 110 is powered again after a sudden power-off occurs while performing a program operation with a write data to at least one selected page coupled to a single word line, the memory system 110 may perform an erase operation to the at least one selected page interrupted due to the sudden power-off and may resume the interrupted program operation with the interrupted write data to the erased page.

Thus, despite of a sudden power-off of the memory system 110, the memory system 110 may stably process the user data and the meta-data for the program operation, thereby more stably performing the program operation.

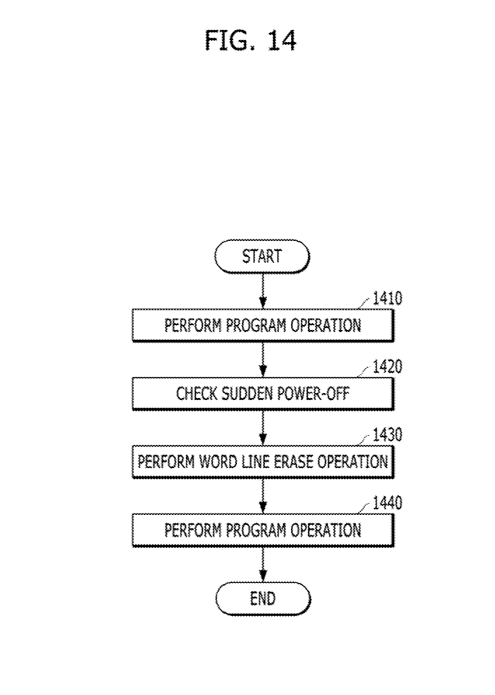

FIG. 14 is a flowchart schematically illustrating the command operation of the memory system 110, according to an embodiment of the present invention.

According to the embodiment of FIG. 14 the memory system 110 may perform the program operation to at least one selected page in a plurality of memory blocks during the power-on of the memory system 110 at step 1410.

At step 1420, upon powered on, the memory system 110 may determine whether the power-off of the memory system 110 immediately before the current power-on was a sudden power-off while performing a program operation to the at least one selected page coupled to a single word line, and whether the program operation is interrupted due to the sudden power-off.

At step 1430, as a result of the determination of step 1420, the memory system 110 may perform an erase operation to the at least one selected page interrupted by the sudden power-off. That is, the memory system 110 may perform the erase operation to the at least one interrupted page coupled to the single word line for rendering the at least one interrupted page into at least one normal empty page, also referred to as an erased at least one selected page.

At step 1440, the memory system 110 may resume the program operation to the erased at least one selected page of step 1430 with the write data, which was interrupted due to the sudden power-off or is the object of the interrupted program operation of step 1420.

At this time, since the operation of performing the program operation received from the host, for example, the write command, the operation of performing the erase operation on the single word line coupled to the at least one page of the memory block in case where the sudden power-off occurred in the memory system during the program operation, and the operation of performing the program operation on the pages of the memory block where the erase operation was performed have been described in detail with reference to FIGS. 12 and 13, the detailed descriptions thereof are omitted herein.

According to the embodiments of the present invention, the memory system and the operating method thereof can minimize the complexity and performance reduction of the memory system and maximize the use efficiency of a memory device, thereby stably processing data.

Although various embodiments have been, described for illustrative purposes, it will be apparent to those skilled in the art that various changes and modifications may be made without departing from the spirit and/or scope of the invention as defined in the following claims.

For example, while the buffers 1210 and 1220 of the controller are described as being part of the memory 144 of the controller, it is noted that they may also form part of a separate memory positioned within or outside of the controller 130, provided that the buffers 1210 and 1220 are operatively coupled to the controller.

What is claimed is:

1. A memory system comprising:
a memory device comprising a plurality of pages and a plurality of word lines; and
a controller suitable for:
performing a program operation to at least one selected page coupled to a single word line;
performing an erase operation to the at least one selected page when the memory system is powered on after a power off interrupted the performing of the program operation to the at least one selected page; and
re-performing the interrupted program operation to the eased at least one selected page.

2. The memory system of claim 1,
wherein the controller stores segments of user data and meta-data corresponding to the program operation into a memory of the controller during the program operation, and
wherein the controller programs first segments of the segments to first pages of the selected pages at a first time point.

3. The memory system of claim 2,
wherein the controller programs second segments of the segments to second pages of the selected pages at a second time point of the power-off,
wherein the controller performs the erase operation to the second pages at a third time point of the power-on after the second time point, and
wherein the controller re-programs the second segments, which are interrupted due to the power-off, to the erased second pages at a fourth time point after the third time point.

4. The memory system of claim 3, wherein the controller converts the second pages into empty pages or free pages through the erase operation at the third time point.

5. The memory system of claim 4,
wherein the first pages and the second pages are coupled to the corresponding word lines, respectively, and
wherein the program operation i an operation of one shot program

6. The memory system of claim wherein the memory device has a triple level cell (TLC) structure.

7. The memory system of claim 1, wherein the controller determines whether the program operation to the selected pages is interrupted due to the power-off before performing the erase operation.

8. The memory system of claim 1, wherein the controller determines whether the selected pages are interrupted due to the power-off before performing the erase operation.

9. The memory system of claim 1, wherein the power-off is a sudden power-off.

10. An operating method of a memory system comprising a controller and a plurality of pages coupled to a plurality of word lines, the operating method comprising:
performing a program operation to selected pages among the plural pages;
performing an erase operation to the selected pages when power of the system is on after the power is off during the performing of the program operation to the selected pages, and
resuming the program operation to the erased pages.

11. The operating method of claim 10, wherein the performing of the program operation comprises:
storing segments of user data and meta-data corresponding to the program operation into a memory in the controller during the command operation; and
programming first segments of the segments to first pages of the selected pages at a first time point.

12. The operating method of claim 11,
wherein the performing of the program operation further comprises programming second segments of the segments to second pages of the selected pages at a second time point,
wherein the erase operation is performed to the second pages at a third time point of the power-on after the second time point, and
wherein the program operation is resumed by re-programming the second segments, which are interrupted due to the power-off, to the erased second pages at a fourth time point after the third time point.

13. The operating method of claim 12, wherein the erase operation is performed by converting the second pages into empty pages or free pages through the erase operation at the third time point.

14. The operating method of claim 3,
wherein the first pages and the second pages are coupled to the corresponding word lines, respectively, and
wherein the program operation is an operation of one shot program.

15. The operating method of claim 14, wherein the plug lit of pages have a triple level cell (TLC) structure.

16. The operating method of claim 10, further comprising determining whether the program operation to the selected pages is interrupted due to the power-off before performing the erase operation.

17. The operating method of claim 10, further comprising determining whether the selected pages are interrupted due to the power-off before the performing of the erase operation.

18. The operating method of claim 10, wherein the power-off is a sudden power-off,
